(19) United States
(12) Patent Application Publication
(10) Pub. No.: US 2026/0233736 A1
(43) Pub. Date: Aug. 13, 2026

(54) METHOD AND SYSTEM FOR SELECTING LANE LINE BASED ON RELIABILITY OF LANE INFORMATION

(71) Applicant: HL Klemove Corp., Incheon (KR)

(72) Inventor: Junsung KWON, Incheon (KR)

(73) Assignee: HL Klemove Corp., Incheon (KR)

(21) Appl. No.: 19/271,281

(22) Filed: Jul. 16, 2025

(30) Foreign Application Priority Data
Feb. 13, 2025 (KR) 10-2025-0018536

(51) Int. Cl. B60W 30/12; G06V 20/56

(52) U.S. Cl. CPC B60W 30/12; G06V 20/588; B60W 2420/403; B60W 2520/105; B60W 2552/53; B60W 2556/10

(57) ABSTRACT

A method for selecting a lane line based on reliability of lane information according to an embodiment of the present disclosure includes: recognizing left and right lane line information of a lane in which an ego vehicle is driving; determining a fault in line information of the lane; if both the left and right lane line information are valid, determining whether a lane width after a predetermined time is less than a predetermined threshold value; if the lane width after the predetermined time is less than the threshold value, determining that both lane lines are valid, and if the lane width after the predetermined time is greater than or equal to the threshold value, determining that either the left lane line or the right lane line is valid; and selecting the lane line determined to be valid as a lane line for controlling the ego vehicle.

### CROSS-REFERENCE TO RELATED APPLICATION

This application claims the benefit of and priority to Korean Patent Application No. 10-2025-0018536 filed on Feb. 13, 2025, the entire disclosures of which are incorporated herein by reference.

### TECHNICAL FIELD

The present disclosure relates to a method and system for selecting a lane line based on the reliability of lane information. More specifically, the present disclosure relates to a method and system for selecting a lane line based on the reliability of lane information, capable of enabling stable path generation by determining the reliability of lane information and selecting reliable lane lines.

### BACKGROUND

In a vehicle, a Driver Assistance System provides support to the driver while driving for the driver's convenience.

In providing functions according to such driver assistance systems, lane information may be used in determining the driving path of the ego vehicle and generating a control path, and lane information may also be used in determining the driving paths of surrounding vehicles and selecting a control target.

Meanwhile, sections where the shapes of the left and right lane lines differ may exist, such as at highway Junctions (JC)/Interchanges (IC), or urban road intersection environments.

Furthermore, in curved roads, the lane line recognition distance shortens, leading to frequent contamination of lane information. At branch roads, one side may be a typical straight driving lane line while the other side is a diverging lane line, resulting in numerous sections where the shapes of the two lane lines differ. Also, in highway Tollgate (TG) sections, the lane width may increase, leading to sections where the shapes of the two lane lines differ.

In such cases, when utilizing lane information ahead to determine a path and control the vehicle, there is a need to filter out misrecognized lane line information and select and utilize reliable lane information.

Therefore, in providing a driver assistance system using lane information, there is a need for a method and system for selecting lane line capable of excluding a misrecognized lane line and selecting a highly reliable lane line.

### SUMMARY

The present disclosure is to solve the problems of the prior art described above, and an object of the present disclosure is to provide a method and system for selecting a lane line capable of determining the reliability of lane information and, based on the reliability, selecting a lane line similar to the previously driven path to enable the generation of a stable path based on the lane line.

Further, an object of the present disclosure is to provide a method and system for selecting a lane line capable of redetermining the coefficient of a lane line of which reliability has continuously decreased after the lane line reliability determination and selection, and then synthesizing the lane information to generate a stable path.

However, the technical problems to be achieved by the embodiments of the present disclosure are not limited to the technical problems described above, and other technical problems may exist.

As a technical means for achieving the above technical problems, a method for selecting a lane line based on reliability of lane information according to an embodiment of the present disclosure comprises: recognizing left and right lane line information of a lane in which an ego vehicle is driving; determining a fault in left and right lane line information of the lane; if both the left and right lane line information are determined to be valid, determining whether a lane width after a predetermined time is less than a predetermined first threshold value; if the lane width after the predetermined time is less than the first threshold value, determining that both lane lines are valid, and if the lane width after the predetermined time is greater than or equal to the first threshold value, determining that either the left lane line or the right lane line is valid; and selecting the lane line determined to be valid as a lane line for controlling the ego vehicle.

Further, the determining of the fault may comprise: for each of the left lane line and the right lane line, determining that the lane line is valid if an amount of change in at least one parameter value compared to previous lane line information is less than a predetermined first threshold parameter value.

Further, if only one of the left lane line or the right lane line is determined to be valid in the determining of the fault, the left lane line or the right lane line determined to be valid may be selected as the lane line for controlling the ego vehicle.

Further, if both the left and right lane line information are determined to have faults in the determining of the fault, both lane lines may be determined to be invalid, and a vehicle control system based on lane line information may be controlled to be an OFF state.

Further, the determining of whether either the left lane line or the right lane line is valid may comprise: determining, from among the left lane line and the right lane line after the predetermined time, the lane line having a smaller lateral distance to the ego vehicle as a valid lane line.

Further, if only one of the left lane line or the right lane line is determined to be valid, the method may further comprise: after the selecting of the lane line, receiving new lane line information.

Further, the method may further comprise: after the new lane line information is received, redetermining a fault in the left and right lane line information based on the received new lane line information, wherein the redetermining of the fault may comprise determining that the lane line information is valid if an amount of change in the at least one parameter value compared to the previous lane line information is less than a predetermined second threshold parameter value, and the second threshold parameter value may be set to be smaller than the first threshold parameter value used in the determining of the fault.

Further, if both the left and right lane line information are determined to be valid in the redetermining of the fault, the method may further comprise: redetermining a current lane width based on whether the lane width at a current position is less than a predetermined second threshold value, wherein the second threshold value may be set to be smaller than the first threshold value.

Further, if the lane width at the current position is less than the second threshold value, existing lane line selection is released, the left and right lane lines according to the received new lane line information may be selected, and the ego vehicle may be controlled by the selected lane lines.

Further, if at least one of the left or right lane line information is determined not to be valid in the redetermining of the fault, or if the lane width at the current position is determined to be greater than or equal to the second threshold value in the redetermining of the current lane width, existing lane line selection may be maintained.

A system for selecting a lane line based on reliability of lane information according to an embodiment of the present disclosure comprises: a first sensor configured to detect left and right lane lines of a lane in which an ego vehicle is driving; a second sensor configured to detect body information of the ego vehicle; and a controller comprising at least one processor configured to select a lane line for controlling the ego vehicle based on detection information from the first sensor and the second sensor, wherein the controller is configured to: determine a fault in the left and right lane line information; if both the left and right lane line information are determined to be valid, determine whether a lane width after a predetermined time is less than a predetermined first threshold value; if the lane width after the predetermined time is less than the first threshold value, determine that both lane lines are valid; if the lane width after the predetermined time is greater than or equal to the first threshold value, determine that either the left lane line or the right lane line is valid; and select the lane line determined to be valid as the lane line for controlling the ego vehicle.

Further, the system may further comprise a previous lane information provider configured to provide lane line information of a time point prior to a time point when the ego vehicle is driving, wherein the controller may be configured to determine that a lane line is valid, for each of the left lane line and the right lane line, if an amount of change in at least one parameter value compared to previous lane line information provided by the previous lane information provider is less than a predetermined first threshold parameter value.

Further, if only one of the left lane line or the right lane line is determined to be valid, the controller may be configured to select the left lane line or right lane line determined to be valid as the lane line for controlling the ego vehicle.

Further, if the lane width after the predetermined time is greater than or equal to the first threshold value, the controller may be configured to determine, from among the left lane line and the right lane line after the predetermined time, the lane line having a smaller lateral distance to the ego vehicle as a valid lane line.

Further, if only one of the left lane line or the right lane line is determined to be valid, the controller may be configured to: receive new lane line information after the lane line is selected; and redetermine a fault in the left and right lane line information based on the received new lane line information.

Further, if both the left and right lane line information are determined to be valid through the redetermination, the controller may be configured to determine whether a lane width at a current position is less than a predetermined second threshold value.

Further, if the lane width at the current position is less than the second threshold value, the controller may be configured to: release an existing lane line selection; select the left and right lane lines based on the received new lane line information; and control the ego vehicle based on the selected lane lines.

Further, the first sensor may comprise a front camera, and the second sensor may comprise at least one of a speed sensor or an acceleration sensor.

Further, the controller may be connected to a path generation apparatus configured to generate a driving path for the ego vehicle, and the path generation apparatus may be configured to generate a lane-based path based on the lane line selected by the controller.

Meanwhile, in a non-transitory computer-readable recording medium that records a program for executing a method for selecting a lane line based on reliability of lane information according to an embodiment of the present disclosure, the method comprises: recognizing left and right lane line information of a lane in which an ego vehicle is driving; determining a fault in left and right lane line information of the lane; if both the left and right lane line information are determined to be valid, determining whether a lane width after a predetermined time is less than a predetermined first threshold value; if the lane width after the predetermined time is less than the first threshold value, determining that both lane lines are valid, and if the lane width after the predetermined time is greater than or equal to the first threshold value, determining that either the left lane line or the right lane line is valid; and selecting the lane line determined to be valid as a lane line for controlling the ego vehicle.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, it is possible to provide a method and system for selecting a lane line based on reliability of lane information that prevent misjudgment and miscontrol by not using misrecognized lane information in lane shape-varying sections such as curved roads, and enable proactive response to lane line changes by predicting the shape of the lane lines ahead using the driving information of the ego vehicle.

Further, according to the present disclosure, by providing an integrated configuration of lane information fault, lane selection function, and selection release function, it is possible to provide a method and system for selecting a lane line based on reliability of lane information that enable flexible utilization and conversion of lane information regardless of the number of utilized lane lines.

However, the effects obtainable from the present disclosure are not limited to the effects described above, and other effects may exist.

### BRIEF DESCRIPTION OF THE DRAWINGS

FIG. 1 is a control flowchart showing a method for selecting a lane line based on reliability of lane information according to an embodiment of the present disclosure.

FIG. 2 is a diagram for explaining the fault determination of left and right lane line information based on the comparison between the amount of change in at least one lane line parameter and a first threshold parameter value, in the method for selecting a lane line based on reliability of lane information according to the embodiment of the present disclosure.

FIG. 3 is a control flowchart showing in more detail the lane line selection method when new lane line information is received after the lane line selection step, in the method for selecting a lane line based on reliability of lane information according to the embodiment of the present disclosure.

FIG. 4 is a diagram for explaining the fault determination of left and right lane line information based on the comparison between the amount of change in at least one lane line parameter and a second threshold parameter value, in the method for selecting a lane line based on reliability of lane information according to the embodiment of the present disclosure.

FIG. 5 is a control configuration diagram schematically showing the configuration of a system for selecting a lane line based on reliability of lane information according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for selecting a lane line based on the reliability of lane information, capable of enabling stable path generation by selecting reliable lane line information.

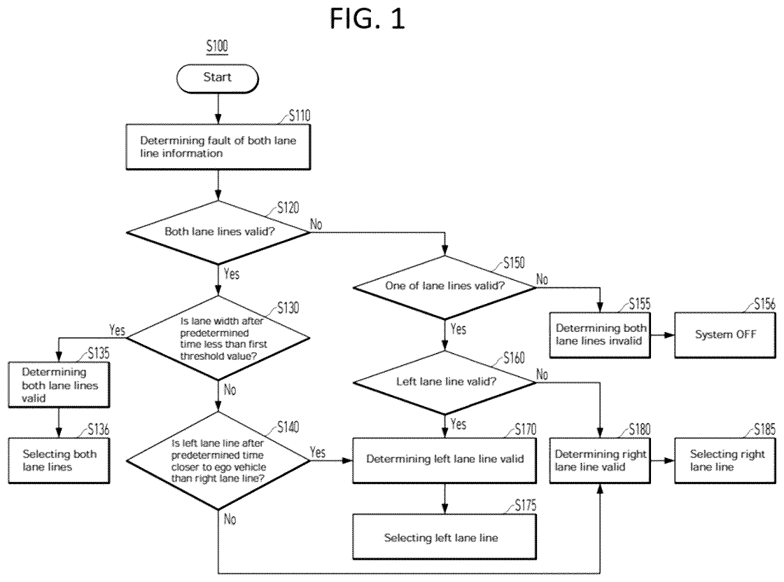

FIG. 1 is a control flowchart showing a method for selecting a lane line based on reliability of lane information according to an embodiment of the present disclosure.

First, referring to FIG. 1, the method for selecting a lane line based on reliability of lane information S100 according to an embodiment of the present disclosure may comprise: recognizing left and right lane line information of the lane in which the ego vehicle is driving; and determining a fault in recognized left and right lane line information S110. Lane line information recognition may be performed, for example, by a front camera installed in the ego vehicle.

Further, the determination of a fault in lane line information may be performed by comparing previous lane line information with current lane line information, and specifically by comparing at least one parameter value between a previous lane line parameter and a current lane line parameter.

For example, for each of the left and right lane lines, by comparing at least one parameter value related to at least one of the current lane line's position, heading angle, or curvature with the previous lane line, if the difference (amount of change) is less than a predetermined threshold value (first threshold parameter value), the lane line may be determined to be valid. This is based on determining a lane line similar to the past lane line information as valid, and determining a current lane line with quite difference from the past lane line information as not valid.

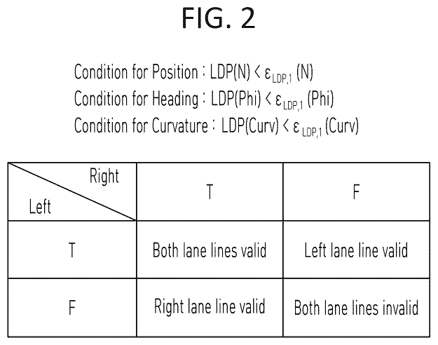

FIG. 2 is a diagram for explaining the fault determination of left and right lane line information based on the comparison between the amount of change in at least one lane line parameter and a first threshold parameter value, in the method for selecting a lane line based on reliability of lane information according to the embodiment of the present disclosure.

Referring to FIG. 2, for each of the left and right lane lines, regarding the determination of lane line validity based on the difference (amount of change) between at least one past lane line parameter and at least one current lane line parameter according to the Lane Detection Process (LDP), the conditions for position, heading, and curvature may include: Condition for Position:

$$Condition for Position : LDP ( N ) < {ε}_{LDP , 1} ( N ) ,$$

$$Condition for Heading : LDP ( Phi ) < {ε}_{LDP , 1} ( Phi ) ,$$

$$Condition for Curvature : LDP ( Curv ) < {ε}_{LDP , 1} ( Curv ) .$$

For example, if all three conditions are met, it may be considered True (T), and the corresponding lane line (left or right lane line) may be determined to be valid. Here, ε_{LDP,1}(N), ε_{LDP,1}(Phi), ε_{LDP,1}(Curv) may be predetermined threshold values (threshold parameter values) related to the difference (amount of change) in lane line parameters.

Meanwhile, if any one of the three conditions is not met, it may be considered False (F), and the corresponding lane line may be determined to be invalid. The table shown in FIG. 2 indicates the validity determination for each lane line through True, False judgments for the left and right lane lines respectively.

Referring again to FIG. 1, if both the left and right lane lines are determined to be True in the lane line fault determination step S110 (‘Yes’ in S120), it may be determined whether the lane width after a predetermined time is less than a predetermined first threshold value (S130). On the other hand, if it is determined that not both left and right lane lines are True (‘No’ in S120), it is determined whether only one of the left lane line or the right lane line is valid (S150). If it is determined that neither the left nor the right lane line is valid (‘No’ in S150), it may be determined that both lane lines are invalid (S155). If both lane lines are invalid, the vehicle control based on lane line may be controlled to the OFF state (S156).

If only one of the left lane line or the right lane line is True (‘Yes’ in S150), it may be determined whether the left lane line is valid (S160). If the left lane line is valid (‘Yes’ in S160), a left lane line valid determination may be made (S170). If the right lane line is valid (‘No’ in S160), a right lane line valid determination may be made (S180).

Meanwhile, if both the left and right lane line information are determined to be valid (‘Yes’ in S120), determining whether the lane width after a predetermined time is less than a predetermined first threshold value S130 is intended for selecting a reliable lane line in a lane-varying section. Here, the predetermined time may be, for example, 1 second, but is not limited thereto.

That is, in the embodiment of the present disclosure, if both lane lines are determined to be valid, the lane width after predetermined time (e.g., 1 second) may be determined, thereby allowing for a more reliable lane line selection.

Meanwhile, in determining the lane width after 1 second, the lane width may be determined by calculating the position value of the lane line after 1 second. Specifically, the lane line equation may be represented by the following 3rd-degree polynomial.

$$y = {c}_{0} \cdot x + {c}_{1} \cdot {x}^{2} + {c}_{2} \cdot {x}^{2} + {c}_{3} \cdot {x}^{3} \qquad [ Equation 1 ]$$

Here, the longitudinal position value after 1 second based on the ego vehicle is dS=Ego Velocity*1 (sec) (Ego Velocity is the speed of the ego vehicle). The lane line coefficients (c₀, c₁, c₂, c₃) for the left lane line may be represented as [Pos_{Le}, Heading_{Le}, Curv_{Le}, CurvD_{Le}], and the lane line coefficients (c₀, c₁, c₂, c₃) for the right lane line can be represented as [Pos_{Ri}, Heading_{Ri}, Curv_{Ri} CurvD_{Ri}], respectively.

Accordingly, the lateral position of the left lane line and the lateral position of the right lane line after 1 second may be represented by Equations 2 and 3 below, respectively.

$${N}_{L e} ( 1 s ) = {Pos}_{L e} + {Heading}_{Le} \cdot dS + {Curv}_{L e} \cdot {dS}^{2} + {CurvD}_{L e} \cdot {dS}^{3} \qquad [ Equation 2 ]$$

$${N}_{R i} ( 1 s ) = {Pos}_{Ri} + {Heading}_{Ri} \cdot dS + {Curv}_{R i} \cdot {dS}^{2} + {CurvD}_{Ri} \cdot {dS}^{3} \qquad [ Equation 3 ]$$

Subsequently, by summing the lateral position of the left lane line N_{Le}(1s) and the lateral position of the right lane line after 1 second N_{Ri}(1s), the width of the lane line after 1 second Wₗₐₙₑ(1s) can be obtained as shown in Equation 4 below.

$${W}_{lane} ( 1 s ) = ‖ {N}_{L e} ( 1 s ) ‖ + ‖ {N}_{R i} ( 1 s ) ‖ \qquad [ Equation 4 ]$$

Next, by comparing the lane line width after 1 second with a predetermined first threshold value ε_{Lane width}, if it is smaller than the first threshold value (‘Yes’ in S130), it may be determined that both lane lines are valid (S135). In this case, both the left and right lane lines are selected, and lane line-based vehicle control may be performed (S136).

In contrast, if the lane line width after 1 second is greater than or equal to the predetermined threshold value (‘No’ in S130), the lateral positions of the lane lines after 1 second are considered, and it may determined which lane line among the left and right lane lines, is closer to the ego vehicle (S140). If the left lane line is closer to the ego vehicle (‘Yes’ in S140) (i.e., N_{Le}(1s)<N_{Ri}(1s)), it may be determined that the left lane line is valid (S170). If the right lane line is closer to the ego vehicle (‘No’ in S140) (i.e., N_{Le}(1s)>N_{Ri}(1s)), it may be determined that the right lane line is valid (S180).

Determining in this way is because if the lane width after 1 second is greater than or equal to the first threshold value, it is a case where stable lane line-based driving is difficult. Since driving along the center of the lane may result in unstable driving in this case, selecting one reliable lane line information from the left and right sides allows for more stable driving. That is, if the lane width is wide and stable driving is difficult, selecting one (left or right) lane line similar to the driving direction allows for maintaining control continuity and promoting driving stability.

As such, if only one of the left lane line or the right lane line is determined to be valid (S170 or S180), the valid lane line is selected, and lane line-based vehicle driving may be performed (S175 or S185).

According to the embodiment of the present disclosure as described above, the reliability of lane information can be accurately determined, for example, while the ego vehicle is driving on a highway. Accordingly, even in diverging situations such as Tollgate (TG), Interchange (IC) and Junction (JC), where the lane width increases or the shapes of the two lane lines are not similar, by selecting a lane line similar to the previously driven path and by performing the lane line-based driving accordingly, it is possible to enable the generation of a stable path.

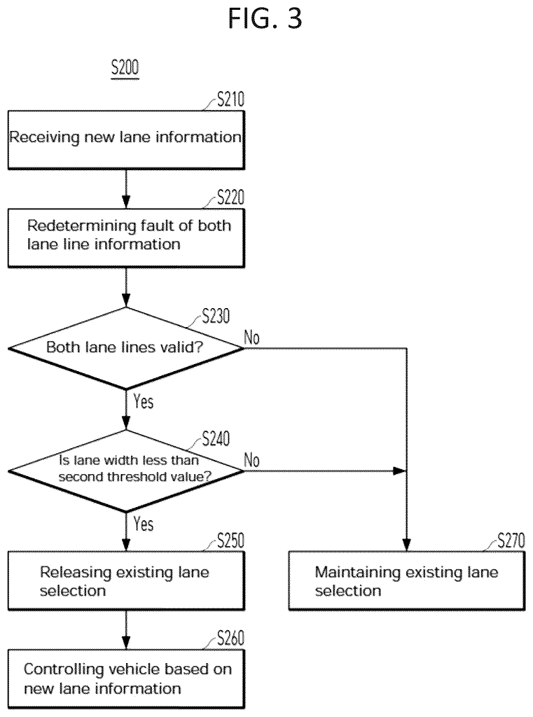

FIG. 3 is a control flowchart showing in more detail the lane line selection method when new lane line information is received after the lane line selection step, in the method for selecting a lane line based on reliability of lane information according to the embodiment of the present disclosure.

FIG. 3 may illustrate a situation where, for example, during driving based on a valid left or right lane line in a case where only one side lane line was determined to be invalid in the initial lane line selection (in the lane line information fault determination step or lane line validity determination step in FIG. 1), new lane line information is received, and it may be determined whether to release the existing selection of the lane line (left or right lane line) or maintain the existing selection.

Referring to FIG. 3, the lane line selection method when new lane line information is received S200 may comprise receiving new lane line information S210. When new lane line information is received, redetermining a fault in the left and right lane line information based on the received lane line information S220 may be performed.

Meanwhile, in the lane line information a fault redetermination step S220, similar to the lane line information fault determination step S110 in FIG. 1, for each of the left and right lane lines, at least one parameter value related to the position, heading angle, and curvature of the lane line compared to the previous lane line may be compared. If the difference (amount of change) is less than a predetermined second threshold parameter value, the lane line may be determined to be valid.

However, in the lane line information fault redetermination step S220, to prevent frequent selection and release of the lane line, it is preferable that the second threshold parameter value is set smaller than the first threshold parameter value in the lane line information fault determination step S110.

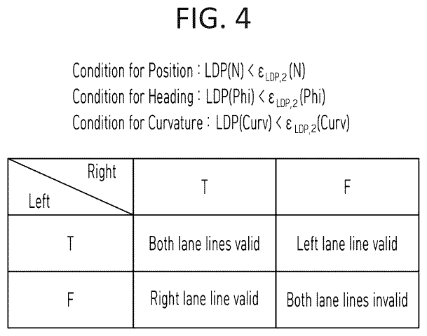

FIG. 4 is a diagram for explaining the fault determination of left and right lane line information based on the comparison between the amount of change in at least one lane line parameter and a second threshold parameter value, in the method for selecting a lane line based on reliability of lane information according to the embodiment of the present disclosure.

Referring to FIG. 4, regarding the determination of lane line validity based on the difference (amount of change) between previous lane line parameters and current lane line parameters, the conditions for position, heading, and curvature may include: Condition for Position:

$$Condition for Position : LDP ( N ) < {ε}_{LDP , 2} ( N ) ,$$

$$Condition for Heading : LDP ( Phi ) < {ε}_{LDP , 2} ( Phi ) ,$$

$$Condition for Curvature : LDP ( Curv ) < {ε}_{LDP , 2} ( Curv ) .$$

If all three conditions are met, it may be considered True (T), and the corresponding lane line (left or right lane line) may be determined to be valid. Here, ε_{LDP,2}(N), ε_{LDP,2}(Phi), ε_{LDP,2}(Curv) may be predetermined threshold values (threshold parameter values) related to the difference (amount of change) in lane line parameters. Meanwhile, as described above, to prevent frequent selection and release of the lane line, the second threshold parameter values ε_{LDP,2}(N), ε_{LDP,2}(Phi), ε_{LDP,2}(Curv) may be set to smaller values than ε_{LDP,1}(N), ε_{LDP,1}(Phi), ε_{LDP,1}(Curv), respectively.

The table shown in FIG. 4 indicates the redetermination of validity for each lane line through True, False judgments for the left and right lane lines respectively.

Referring again to FIG. 3, if both the left and right lane lines are determined to be True based on the lane line information fault redetermination step, meaning both left and right lane lines are valid (‘Yes’ in S230), it may be determined whether the lane width is less than a predetermined second threshold value (S240).

Determining the lane width again here is because, in cases where the lane width is determined to be wide and thus both lane lines cannot be considered valid, the existing lane line selection is maintained to promote driving stability. Meanwhile, even in the lane width redetermination, to prevent frequent selection and release of the lane line, a second threshold value may be set smaller than the threshold value at the time of the initial lane width determination in FIG. 1 (first threshold value, ε_{Lane width}).

For example, the second threshold value may be set as ε_{Lane width}−0.2 m, but the present disclosure is not limited thereto, and a certain value smaller than the first threshold value may be set.

Further, unlike the initial lane width determination in FIG. 1, the lane width determination in step S240 may be based on the lane width at the current time point (at the current position of the ego vehicle), not the lane width after a predetermined time (e.g., 1 second). This is to minimize parameter changes associated with lane line selection and release, thereby promoting stable driving.

If both the left and right lane lines are determined to be valid in step S230 (both lane lines ‘True’ determination), and the lane width is less than the predetermined second threshold value in step S240 (‘Yes’ in S240), the existing lane line selection may be released (S250), and the vehicle control based on the lane line may be performed based on the new lane line information (S260).

On the other hand, if at least one of the left or right lane lines is False in step S230 (‘No’ in S230), or if the lane width is greater than or equal to the predetermined second threshold value in step S240 (‘No’ in S240), the existing lane line selection may be maintained (S270), and the vehicle control based on the lane line may be performed based on the previously selected left or right lane line.

According to the embodiment of the present disclosure as described above, by providing an integrated configuration of lane line information validity determination, lane line selection function and release function, flexible utilization and conversion of lane line information can be achieved.

Furthermore, according to the embodiment of FIG. 3, even if both lane lines are determined to be valid based on the existing criteria (criteria at the initial lane line selection), if driving was previously being performed by selecting one lane line, by applying stricter requirements for lane line selection release since the lane line selection release may result in damages for the driving stability, it is possible to perform the vehicle control based on lane line information more effectively.

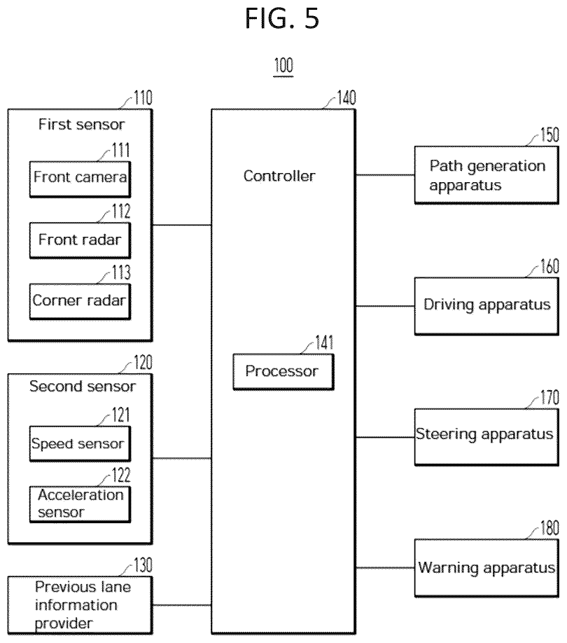

FIG. 5 is a control configuration diagram schematically showing the configuration of a system for selecting a lane line based on reliability of lane information according to embodiments of the present disclosure.

Referring to FIG. 5, the system for selecting a lane line based on reliability of lane information 100 according to embodiments of the present disclosure may comprise: a first sensor 110 configured to detect left and right lane lines of a lane in which the ego vehicle is driving; a second sensor 120 configured to detect vehicle body information; and a controller 140 comprising at least one processor 141 configured to select a lane line for controlling the ego vehicle based on detection information from the first sensor 110 and the second sensor 120.

The controller 140 may determine a fault in the left and right lane line information. If both left and right lane line information are determined to be valid, the controller 140 may determine whether the lane width after a predetermined time is less than a predetermined first threshold value. If the lane width after the predetermined time is less than the first threshold value, the controller 140 may determine both lane lines are valid. If the lane width after the predetermined time is greater than or equal to the first threshold value, the controller 140 may determine either one of the left lane line or the right lane line is valid. The controller 140 then may select the lane line determined to be valid as the lane line for controlling the ego vehicle.

The first sensor 110 may include a front camera 111. Further, the first sensor 110 may additionally include at least one of a front radar 112 or a corner radar 113. However, the sensors included in the first sensor (110) are not limited thereto, and may additionally include other types of sensors for detecting the surroundings of the ego vehicle, such as lidar sensors, ultrasonic sensors, etc.

The second sensor 120 may include at least one of a speed sensor 121 or an acceleration sensor 122. Further, the second sensor 120 may additionally include other types of sensors for detecting the body information of the ego vehicle.

Further, the system for selecting a lane line based on reliability of lane information 100 according to embodiments of the present disclosure may further comprise a previous lane information provider 130 that provides lane information from a time point prior to the current driving time point of the ego vehicle.

The controller 140 may determine, for the left and right lane lines, the lane line to be valid if an amount of change in at least one parameter value compared to the previous lane line information provided by the previous lane information provider 130 satisfies being less than a predetermined first threshold parameter value.

Further, if only one of the left lane line or the right lane line is determined to be valid, the controller 140 may select the left or right lane line determined to be valid as the lane line for controlling the ego vehicle.

Further, if the lane width after the predetermined time is greater than or equal to the first threshold value, the controller 140 may determine the lane line with the smaller lateral distance to the ego vehicle among the left and right lane lines after the predetermined time as the valid lane line.

Further, if only one of the left lane line or the right lane line is determined to be valid, the controller 140 may receive new lane line information after the lane line selection, and redetermine a fault in the left and right lane line information based on received new lane line information.

Further, if both left and right lane line information are determined to be valid through the lane line information fault redetermination, the controller 140 may determine whether the lane width at the current position is less than a predetermined second threshold value.

Further, if the lane width at the current position is less than the predetermined second threshold value, the controller 140 may release the existing lane line selection, select the left and right lane lines based on the received new lane line information, and control the ego vehicle based on the selected lane lines.

Further, the controller 140 may be connected to a path generation apparatus 150 configured to generate the driving path of the ego vehicle. The path generation apparatus 150 may generate a lane-based path based on the lane line selected by the controller 140.

Further, the controller 140 may be connected to a driving apparatus 160 configured to control the longitudinal driving (acceleration or deceleration) of the ego vehicle and a steering apparatus 170 configured to control the lateral driving of the ego vehicle. Based on the driving path generated by the path generation apparatus 150, at least one of the driving apparatus 160 or the steering apparatus 170 may be controlled to control the lane-based driving of the ego vehicle.

Further, the controller 140 may be connected to a warning apparatus 180 configured to provide notification to the driver of the ego vehicle. The controller 140 may control the warning apparatus 180 to provide notification to the driver regarding the driving of the ego vehicle along the generated path. For example, through the control of the warning apparatus 180, driver warnings according to driver assistance functions such as the Lane Departure Warning (LDW) system based on lane line recognition may be provided.

Meanwhile, the method for selecting a lane line based on reliability of lane information according to the embodiment of the present disclosure performed by the controller 140 has been described in detail above, so a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, the reliability of lane line information during highway driving is determined, and when the lane width increases or the shapes of both lane lines are not similar, a lane line similar to the previously driven path can be found and selected. Accordingly, it is possible to provide a method and system for selecting a lane line based on the reliability of lane information that provides a stable path generation function based on lane lines.

Further, according to the method and system for selecting a lane line based on the reliability of lane information according to the embodiments of the present disclosure, by utilizing the ego vehicle's driving information, the shape of the lane lines ahead can be predicted to respond proactively. Furthermore, by enabling confirmation of the reliability of future time point lane information through the reliability confirmation of the current time point lane information and lane width varying detection, it is possible to maximize the utilization of lane information.

In addition, according to the embodiments of the present disclosure, by providing integrated functions for lane line selection and release, and enabling filtering and selection of lane information using only sensors mounted at the ego vehicle, a lane line selection method and system applicable to various environments can be provided.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting.

For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

100: System for selecting lane line based on reliability of lane information
110: First sensor
111: Front camera
112: Front radar
113: Corner radar
120: Second sensor
121: Speed sensor
122: Acceleration sensor
130: Previous lane information provider
140: Controller
141: Processor
150: Path generation apparatus
160: Driving apparatus
170: Steering apparatus
180: Warning apparatus

1. A method for selecting a lane line based on reliability of lane information, comprising:
recognizing left and right lane line information of a lane in which an ego vehicle is driving;
determining a fault in left and right lane line information of the lane;
if both the left and right lane line information are determined to be valid, determining whether a lane width after a predetermined time is less than a predetermined first threshold value;
if the lane width after the predetermined time is less than the first threshold value, determining that both lane lines are valid, and if the lane width after the predetermined time is greater than or equal to the first threshold value, determining that either the left lane line or the right lane line is valid; and
selecting the lane line determined to be valid as a lane line for controlling the ego vehicle.

2. The method of claim 1, wherein the determining of the fault comprises:
for each of the left lane line and the right lane line, determining that the lane line is valid if an amount of change in at least one parameter value compared to previous lane line information is less than a predetermined first threshold parameter value.

3. The method of claim 2, wherein if only one of the left lane line or the right lane line is determined to be valid in the determining of the fault, the left lane line or the right lane line determined to be valid is selected as the lane line for controlling the ego vehicle.

4. The method of claim 3, wherein if both the left and right lane line information are determined to have faults in the determining of the fault, both lane lines are determined to be invalid, and a vehicle control system based on lane line information is controlled to be an OFF state.

5. The method of claim 4, wherein the determining of whether either the left lane line or the right lane line is valid comprises:
determining, from among the left lane line and the right lane line after the predetermined time, the lane line having a smaller lateral distance to the ego vehicle as a valid lane line.

6. The method of claim 5, wherein if only one of the left lane line or the right lane line is determined to be valid, the method further comprises:
after the selecting of the lane line, receiving new lane line information.

7. The method of claim 6, further comprising:
after the new lane line information is received, redetermining a fault in the left and right lane line information based on the received new lane line information,
wherein the redetermining of the fault comprises determining that the lane line information is valid if an amount of change in the at least one parameter value compared to the previous lane line information is less than a predetermined second threshold parameter value, and
wherein the second threshold parameter value is set to be smaller than the first threshold parameter value used in the determining of the fault.

8. The method of claim 7, wherein if both the left and right lane line information are determined to be valid in the redetermining of the fault, the method further comprises:
redetermining a current lane width based on whether the lane width at a current position is less than a predetermined second threshold value,
wherein the second threshold value is set to be smaller than the first threshold value.

9. The method of claim 8, wherein if the lane width at the current position is less than the second threshold value, existing lane line selection is released, the left and right lane lines according to the received new lane line information are selected, and the ego vehicle is controlled by the selected lane lines.

10. The method of claim 8, wherein if at least one of the left or right lane line information is determined not to be valid in the redetermining of the fault, or if the lane width at the current position is determined to be greater than or equal to the second threshold value in the redetermining of the current lane width, existing lane line selection is maintained.

11. A system for selecting a lane line based on reliability of lane information, comprising:
a first sensor configured to detect left and right lane lines of a lane in which an ego vehicle is driving;
a second sensor configured to detect body information of the ego vehicle; and
a controller comprising at least one processor configured to select a lane line for controlling the ego vehicle based on detection information from the first sensor and the second sensor,
wherein the controller is configured to:
determine a fault in the left and right lane line information;
if both the left and right lane line information are determined to be valid, determine whether a lane width after a predetermined time is less than a predetermined first threshold value;
if the lane width after the predetermined time is less than the first threshold value, determine that both lane lines are valid;
if the lane width after the predetermined time is greater than or equal to the first threshold value, determine that either the left lane line or the right lane line is valid; and
select the lane line determined to be valid as the lane line for controlling the ego vehicle.

12. The system of claim 11, further comprising a previous lane information provider configured to provide lane line information of a time point prior to a time point when the ego vehicle is driving,
wherein the controller is configured to determine that a lane line is valid, for each of the left lane line and the right lane line, if an amount of change in at least one parameter value compared to previous lane line information provided by the previous lane information provider is less than a predetermined first threshold parameter value.

13. The system of claim 12, wherein if only one of the left lane line or the right lane line is determined to be valid, the controller is configured to select the left lane line or right lane line determined to be valid as the lane line for controlling the ego vehicle.

14. The system of claim 13, wherein if the lane width after the predetermined time is greater than or equal to the first threshold value, the controller is configured to determine, from among the left lane line and the right lane line after the predetermined time, the lane line having a smaller lateral distance to the ego vehicle as a valid lane line.

15. The system of claim 14, wherein if only one of the left lane line or the right lane line is determined to be valid, the controller is configured to:
receive new lane line information after the lane line is selected; and
redetermine a fault in the left and right lane line information based on the received new lane line information.

16. The system of claim 15, wherein if both the left and right lane line information are determined to be valid through the redetermination, the controller is configured to determine whether a lane width at a current position is less than a predetermined second threshold value.

17. The system of claim 16, wherein if the lane width at the current position is less than the second threshold value, the controller is configured to:
release an existing lane line selection;
select the left and right lane lines based on the received new lane line information; and
control the ego vehicle based on the selected lane lines.

18. The system of claim 11, wherein the first sensor comprises a front camera, and the second sensor comprises at least one of a speed sensor or an acceleration sensor.

19. The system of claim 18, wherein the controller is connected to a path generation apparatus configured to generate a driving path for the ego vehicle, and
the path generation apparatus is configured to generate a lane-based path based on the lane line selected by the controller.

20. A non-transitory computer-readable recording medium that records a program for executing a method for selecting a lane line based on reliability of lane information on a computer, the method comprising:
recognizing left and right lane line information of a lane in which an ego vehicle is driving;
determining a fault in left and right lane line information of the lane;
if both the left and right lane line information are determined to be valid, determining whether a lane width after a predetermined time is less than a predetermined first threshold value;
if the lane width after the predetermined time is less than the first threshold value, determining that both lane lines are valid, and if the lane width after the predetermined time is greater than or equal to the first threshold value, determining that either the left lane line or the right lane line is valid; and
selecting the lane line determined to be valid as a lane line for controlling the ego vehicle.
